(19) United States
(12) Patent Application Publication
(10) Pub. No.: US 2014/0171137 A1
(43) Pub. Date: Jun. 19, 2014

(54) COMMUNICATION DEVICE AND CONTROL DEVICE FOR CONTROLLING COMMUNICATION LINKAGE BETWEEN COMMUNICATION DEVICES

(71) Applicant: ELECTRONICS AND TELECOMMUNICATIONS RESEARCH INSTITUTE, Daejeon (KR)

(72) Inventors: Seung-Hun OH, Gwangju (KR); Sim-Kwon YOON, Gwangju (KR); Hong Yeon YU, Gwangju (KR); Byung-Tak LEE, Gyeonggi-do (KR); Young Sun KIM, Daejeon (KR)

(73) Assignee: Electronics and Telecommunications Research Institute, Daejeon (KR)

(21) Appl. No.: 13/874,952

(22) Filed: May 1, 2013

(30) Foreign Application Priority Data
Dec. 14, 2012 (KR) 10-2012-0146824

(51) Int. Cl. H04W 72/04

(52) U.S. Cl. CPC H04W 72/0453
USPC 455/509

(57) ABSTRACT

A control device is provided which controls wireless communication linkage between communication devices. The control device includes a communication unit configured to perform wireless communication with first and second communication devices; a user interface unit configured to generate a communication unit active signal according to a control of a user; and a control unit configured to activate the communication unit in response to the communication unit active signal. The communication unit receives communication linkage information for communication linkage between the first and second communication devices from the first communication device and sends the communication linkage information to the second communication device.

### CROSS-REFERENCE TO RELATED APPLICATIONS

A claim for priority under 35 U.S.C. §119 is made to Korean Patent Application No. 10-2012-0146824 filed Dec. 14, 2012, in the Korean Intellectual Property Office, the entire contents of which are hereby incorporated by reference.

### BACKGROUND

The inventive concepts described herein relate to communications, and more particularly, relate to a communication device and a control device of controlling communication linkage between communication devices.

As a communication technique between a sensor network and an object is developed, a concern about communication linkage between communication devices of a network may increase. Communication devices may communicate with one another using various communication interfaces. The communication devices may configure communication linkage by exchanging information for the communication linkage. It is difficult to check whether information for the communication linkage between the communication devices is normally sent. In particular, in wireless communications, it is very difficult to check a communication linkage state between communication devices.

In general, a separate device (e.g., a computer) may be used to check a linkage state between communication devices and to control the linkage. The computer may process linkage information of communication devices using O/S or software, and may provide a user with a processing result visibly such that the user confirms the linkage state of communication devices. However, such general methods may necessitate separate equipment (e.g., a computer). This may mean that a cost increases and a lot of time is required to process linkage information. Also, in the case that appointed ones of installed communication devices are linked, linkage between communication devices may be released from the computer, and then linkage, and then communication devices may be again linked.

### SUMMARY

One aspect of embodiments of the inventive concept is directed to provide a control device which controls wireless communication linkage between communication devices, the control device comprising a communication unit configured to perform wireless communication with first and second communication devices; a user interface unit configured to generate a communication unit active signal according to a control of a user; and a control unit configured to activate the communication unit in response to the communication unit active signal. The communication unit receives communication linkage information for communication linkage between the first and second communication devices from the first communication device and sends the communication linkage information to the second communication device.

In example embodiments, the communication unit communicates with the first and second communication devices using a first communication interface and the communication linkage information is communication linkage information for communicating using a second communication interface different from the first communication interface.

In example embodiments, the first communication interface is an LED, laser or NFC communication interface.

In example embodiments, the second communication interface is a Zigbee, RFID, Bluetooth, UWB or Wireless LAN communication interface.

In example embodiments, the communication linkage information comprises channel linkage information which enables the first and second communication device to communicate with each other using the second communication interface.

In example embodiments, the control device further comprises a display unit configured to display a communication state of the communication unit according to a control of the control unit.

In example embodiments, the user interface unit is formed of a switch, and wherein when the switch is turned on, the user interface unit generates the communication unit active signal.

Another aspect of embodiments of the inventive concept is directed to provide a communication device which comprises a first communication unit which communicates with an external device through a first communication interface and transmits and receives communication linkage information on a second communication interface different from the first communication interface; a second communication unit which communicates with the external device through the second communication interface using the communication linkage information received from the first communication unit; a user interface unit which generates a communication unit active signal according to a control of a user; and a control unit which activates the first communication unit in response to the communication unit active signal.

In example embodiments, the communication device further comprises a display unit configured to display a communication state of the first or second communication unit according to a control of the control unit.

In example embodiments, the communication linkage information comprises channel linkage information which enables the communication device to communicate with the external device using the second communication interface.

In example embodiments, the first communication interface is an LED, laser or NFC communication interface and the second communication interface is a Zigbee, RFID, Bluetooth, UWB or Wireless LAN communication interface.

With embodiments of the inventive concept, a control device may control communication linkage between communication devices. Also, the control device may simplify a communication linkage process between the communication devices. Further, a communication device may simplify a communication linkage process between the communication devices.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a communication system according to an embodiment of the inventive concept;

FIG. 2 is a detailed block diagram of a communication device of FIG. 1;

FIG. 3 is a timing diagram for describing operations of a communication device and a control device of FIG. 1;

FIG. 4 is a flow chart illustrating a control method according to an embodiment of the inventive concept;

FIG. 5 is a detailed block diagram of a communication device according to another embodiment of the inventive concept; and

FIG. 6 is a timing diagram for describing operations of communication devices of FIG. 5.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

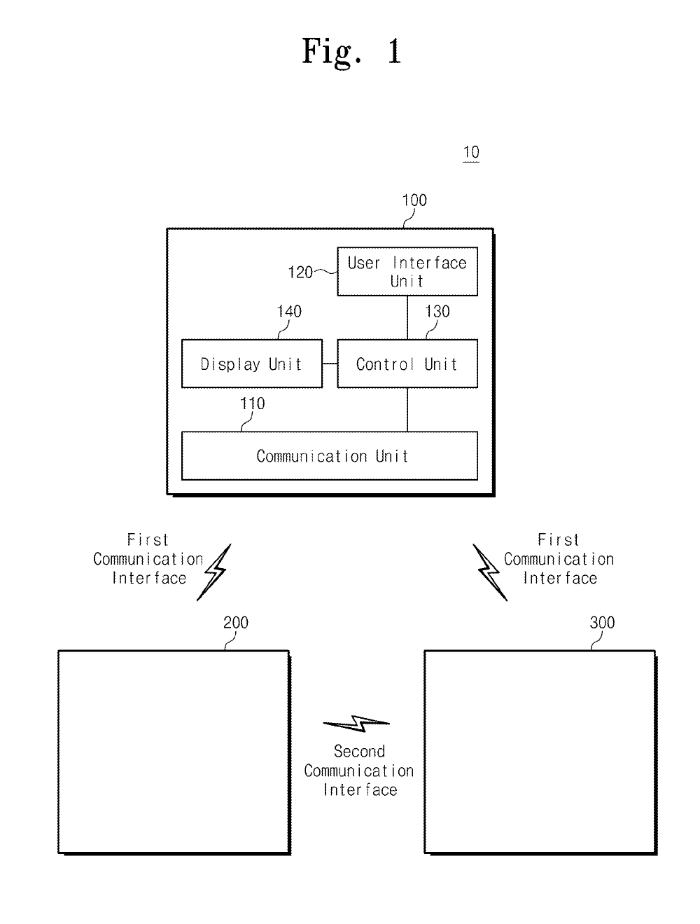

FIG. 1 is a block diagram schematically illustrating a communication system according to an embodiment of the inventive concept.

Referring to FIG. 1, a communication system 10 according to an embodiment of the inventive concept may include a control device 100 and communication devices 200 and 300.

The control device 100 may control communication linkage between the communication devices 200 and 300. The control device 100 may communicate with the communication devices 200 and 300 using a first communication interface. The communication devices 200 and 300 may communicate with each other using a second communication interface different from the first communication interface. The control device 100 may communicate with the communication devices 200 and 300 using the first communication interface, and may relay the communication linkage using the second communication interface between the communication devices 200 and 300.

For example, the first communication interface may be an LED (Light Emitting Diode), laser or NFC (Near Field Communication) communication interface. However, the inventive concept is not limited thereto. Various communication interfaces requiring guarantee of a rectilinear propagation characteristic may be applied.

For example, the second communication interface may be a Zigbee, RFID, Bluetooth, UWB (Ultra Wide Band) or Wireless LAN communication interface. However, the inventive concept is not limited thereto. Various sorts of wireless communication interfaces may be applied.

Below, it is assumed that the control device 100 and the communication devices 200 and 300 are disposed to be suitable to secure a line of sight for use of the first communication interface. Also, it is assumed that the communication device 200 is a first communication device and the communication device 300 is a second communication device.

The control device 100 may include a communication unit 110, a user interface unit 120, a control unit 130, and a display unit 140.

The communication unit 110 may communicate with the first and second communication devices 200 and 300 using the first communication interface.

The communication unit 110 may receive communication linkage information of the first communication device 200 on the second communication interface from the first communication device 200. The communication unit 110 may provide the second communication device 300 with the communication linkage information of the first communication device 200 on the second communication interface. The communication unit 110 may receive communication linkage information of the second communication device 300 on the second communication interface from the second communication device 300. The communication unit 110 may provide the first communication device 200 with the communication linkage information of the second communication device 300 on the second communication interface. The communication linkage information may include channel information (e.g., frequency, bandwidth, etc.) of the first and second communication devices 200 and 300 on the second communication interface.

The user interface unit 120 may generate a communication unit active signal according to a control of a user. The user interface unit 120 may be formed of a switch (not shown), for example. The user interface unit 120 may be formed of a button switch which is disposed at an outer surface of the control device 100. The user interface unit 120 may generate the communication unit active signal when a switch is turned on by the user.

The control unit 130 may control an operation of the communication unit 110. For example, the control unit 130 may activate the communication unit 110 in response to the communication unit active signal from the user interface unit 120. Although not shown, the control unit 130 may further comprise a memory for storing communication linkage information of the first and second communication devices 200 and 300 from the communication unit 110.

The control unit 130 may control the display unit 140 according to a communication state of the communication unit 110. For example, the control unit 130 may control the display unit 140 to display a transfer state of communication linkage information of the communication unit 110. If the communication unit 110 finishes receiving communication linkage information from the first communication device 200 or the second communication device 300, the control unit 130 may display such a state through the display unit 140.

The display unit 140 may display a communication state of the communication unit 110 according to a control of the control unit 130. For example, the display unit 140 may be formed of a light emitting element (e.g., a diode), a display panel (e.g., an LCD panel, an OLED panel, etc.), or the like.

As described above, the control device 100 according to an embodiment of the inventive concept may control communication linkage through the second communication interface between the first communication device 200 and the second communication device 300. In particular, the communication unit 110 of the control device 100 may relay communication linkage information of the first and second communication devices 200 and 300, communicating with each other through the second communication interface, using the first communication interface. Thus, it is possible to simplify a communication linkage process between the first and second communication devices 200 and 300. Also, since high-priced equipment (e.g., a computer) for communication linkage between the first and second communication devices 200 and 300 is not needed, a cost may be reduced.

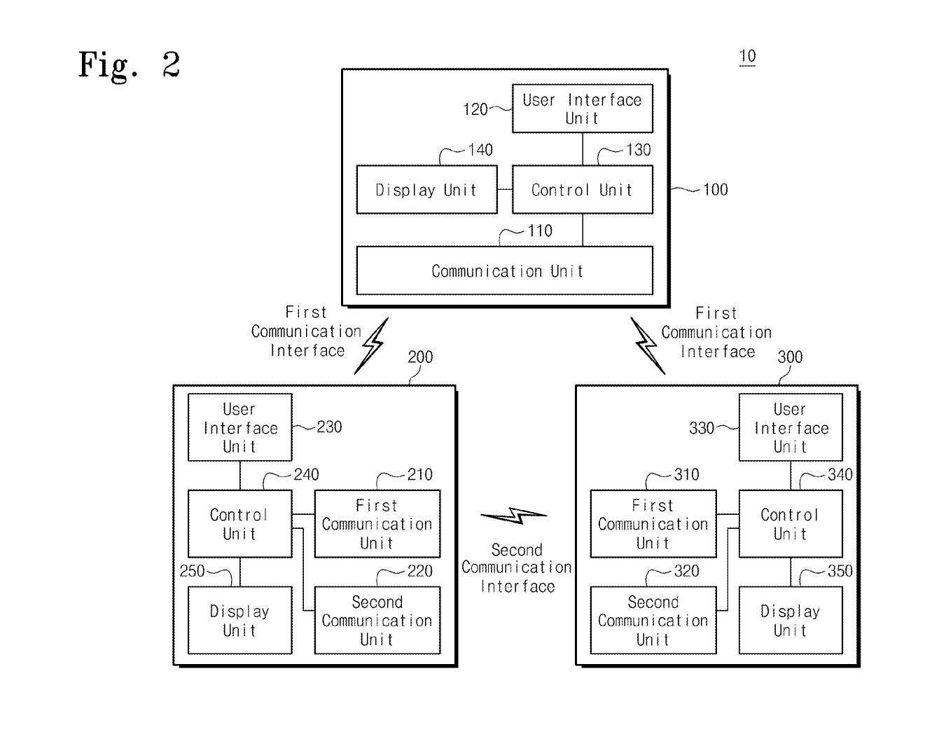

FIG. 2 is a detailed block diagram of a communication device of FIG. 1.

Referring to FIG. 2, a communication system 10 may include a control device 100 and communication devices 200 and 300. The control device 100 may be configured substantially the same as described in FIG. 1. The communication device 300 may be configured substantially the same as the communication device 200. Thus, the communication device 200 will be described to escape a duplicated description.

The communication device 200 may include a first communication unit 210, a second communication unit 220, a user interface unit 230, a control unit 240, and a display unit 250.

The first communication unit 210 may communicate with the control device 100 using a first communication interface. For example, the first communication unit 210 may communicate with the communication unit 110 of the control device 100. The first communication unit 210 may send communication linkage information on the second communication interface to the control device 100. The first communication unit 210 may receive communication linkage information of the second communication device 300 on the second communication interface from the control device 100. The communication linkage information may include channel information (e.g., frequency, bandwidth, etc.) of the communication devices 200 and 300 on the second communication interface.

The second communication unit 220 may communication with the communication device 300 using a second communication interface. The second communication unit 220 may communicate with the communication device 300 using the communication linkage information of the communication device 300 on the second communication interface received from the first communication unit 210.

The user interface unit 230 may generate a communication unit active signal according to a control of a user. The user interface unit 230 may be formed of a switch (not shown), for example. The user interface unit 230 may be formed of a button switch which is disposed at an outer surface of the communication device 200. The user interface unit 230 may generate the communication unit active signal when a switch is turned on by the user.

The control unit 240 may control the first communication unit 210 and the second communication unit 220. For example, the control unit 240 may activate the first communication unit 210 in response to the communication unit active signal provided from the user interface unit 230.

The control unit 240 may provide the second communication unit 220 with communication linkage information of the communication device 300 on the second communication interface received from the first communication unit 210. Although not shown, the control unit 240 may further comprise a memory for storing communication linkage information received from the first communication unit 210.

The control unit 240 may control the display unit 250 according to a communication state of the first communication unit 210 or the second communication unit 220. For example, the control unit 240 may control the display unit 250 to display a transfer state of communication linkage information of the first communication unit 210. If the first communication unit 210 finishes receiving communication linkage information from the control device 100, the control unit 240 may display such a state through the display unit 250.

The display unit 250 may display a communication state of the first communication unit 210 or the second communication unit 220 according to a control of the control unit 240. For example, the display unit 250 may be formed of a light emitting element (e.g., a diode), a display panel (e.g., an LCD panel, an OLED panel, etc.), or the like.

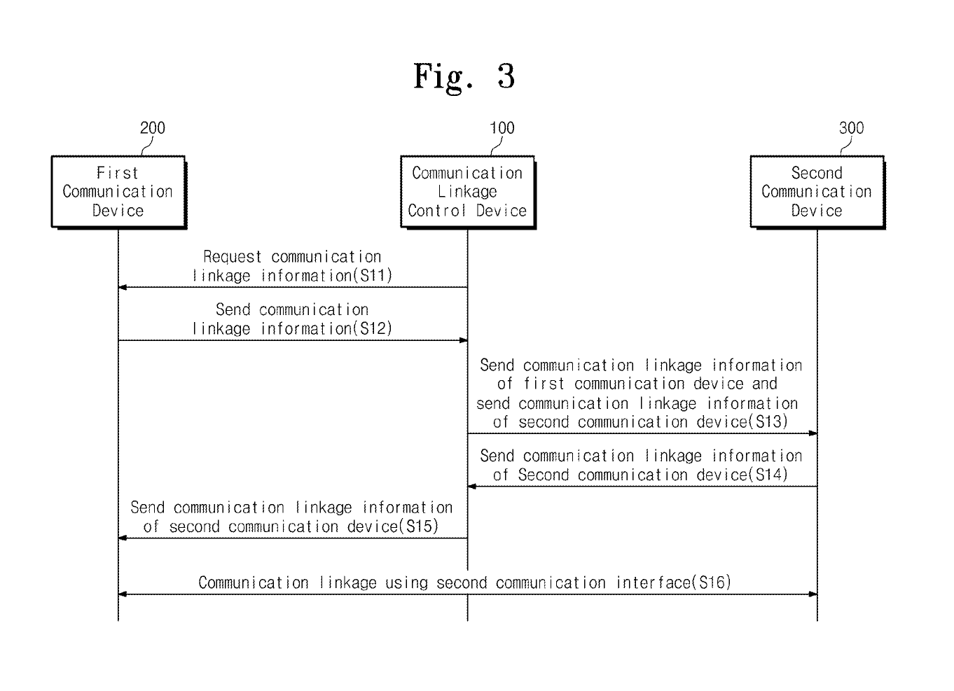

FIG. 3 is a timing diagram for describing operations of a communication device and a control device 100 of FIG. 1.

Referring to FIG. 3, a control device 100 may request communication linkage information on a second communication interface using a first communication interface at a first communication device 200 (S11).

The first communication device 200 may provide the control device 100 with communication linkage information on the second communication interface using the first communication interface (S12).

The control device 100 may provide a second communication device 300 with communication linkage information on the second communication interface of the first communication device 200 using the first communication interface. At the same time or subsequently, the control device 100 may request communication linkage information on second communication interface at the second communication device 300 (S13).

The second communication device 300 may provide the control device 100 with communication linkage information on the second communication interface using the first communication interface (S14).

Operations S13 and S14 may be executed simultaneously or sequentially.

The control device 100 may provide the first communication device 200 with communication linkage information on the second communication interface of the second communication device 300 using the first communication interface (S15).

The first communication device 200 and the second communication device 300 may complete the communication linkage using the communication linkage information on the second communication interface.

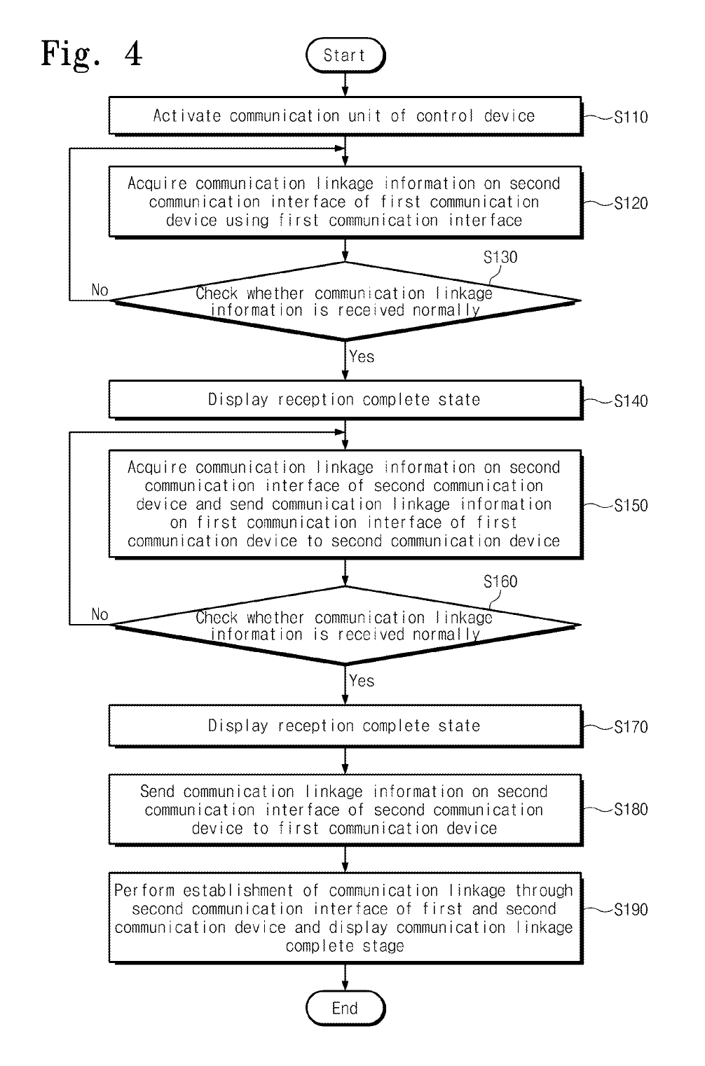

FIG. 4 is a flow chart illustrating a control method according to an embodiment of the inventive concept.

Referring to FIG. 4, a communication linkage control method of communication devices 200 and 300 according to an embodiment of the inventive concept may comprise operations of activating a communication unit of a control device (S110); acquiring communication linkage information on second communication interface of a first communication device using a first communication interface (S120); checking whether the communication linkage information is received normally (S130); displaying a reception complete state when the communication linkage information is received normally (S140); sending communication linkage information on second communication interface of the first communication device and acquiring communication linkage information on the second communication interface of second communication device (S150); checking whether the communication linkage information is received normally (S160); displaying a reception complete state when the communication linkage information is received normally (S170); sending communication linkage information on second communication interface of a second communication device on the second communication interface to the first communication device using the first communication interface (S180); and performing establishment of communication linkage through the second communication interface of first and second communication devices and displaying a communication linkage complete state (S190).

In operation S110, a control unit 130 of a control device 100 may activate a communication unit 110 based on a communication unit active signal transferred from a user interface unit 120.

In operation S120, the communication unit 110 may communicate with a first communication device 200 using a first communication interface. The communication unit 110 may receive communication linkage information of the first communication device 200 on a second communication interface.

In operation S130, the control unit 130 may determine whether the communication linkage information of the first communication device 200 is normally received. If the communication linkage information of the first communication device 200 is decided to be normally received, the method proceeds to operation S140. If the communication linkage information of the first communication device 200 is decided to be abnormally received, the method proceeds to operation S120.

In operation S140, a display unit 140 may display a reception complete state of the communication linkage information.

In operation S150, the communication unit 110 may communicate with a second communication device 300 using the first communication interface. The communication unit 110 may send communication linkage information of the first communication device 200 on the second communication interface. The communication unit 110 may receive the communication linkage information of the second communication device 300 on the second communication interface.

Operation S160 may be executed the same as operation S130, and operation S170 may be executed the same as operation S140.

In operation S180, the communication unit 110 may again communicate with the first communication device 200 using the first communication interface. The communication unit 110 may provide the first communication device 200 with the communication linkage of the second communication device 300 on the second communication interface.

In operation S190, each of the first communication device 200 and the second communication device 300 may complete communication linkage using the communication linkage on the second communication interface. The first communication device 200 and the second communication device 300 may display a communication linkage complete state through a display unit 250 and a display unit 350, respectively.

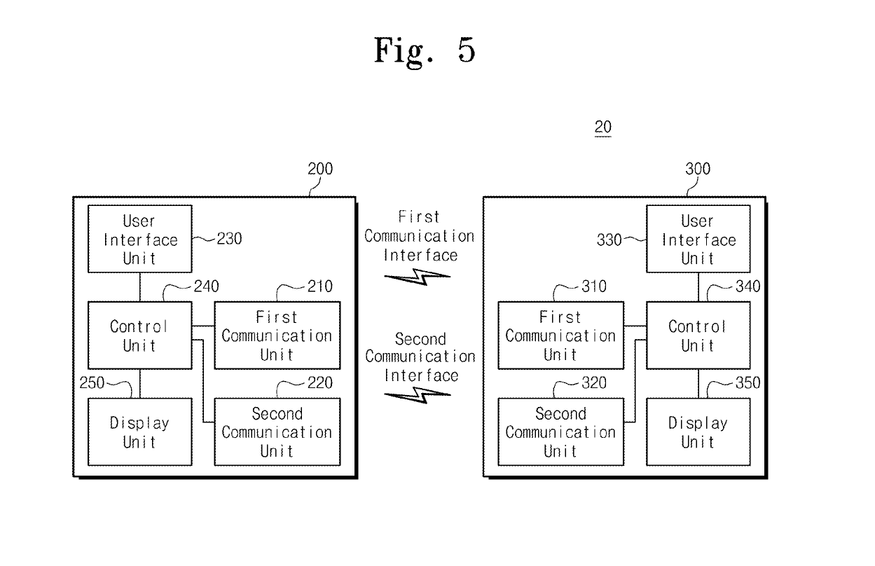

FIG. 5 is a detailed block diagram of a communication device according to another embodiment of the inventive concept.

Referring to FIG. 5, a communication system 20 may include communication devices 200 and 300. The communication device 300 may be configured substantially the same as the communication device 200. Thus, the communication device 200 will be described to escape a duplicated description.

The communication device 200 may include a first communication unit 210, a second communication unit 220, a user interface unit 230, a control unit 240, and a display unit 250.

The first communication unit 210 may communicate with the communication device 300 using a first communication interface. For example, the first communication unit 210 may communicate with a first communication unit 310 of the communication device 300 using the first communication interface. The first communication unit 210 may send communication linkage information on a second communication interface to the communication unit 310 of the communication device 300. The first communication unit 210 may receive communication linkage information of the communication device 300 on the second communication interface from the communication unit 310. The communication linkage information may include channel information (e.g., frequency, bandwidth, etc.) of the communication devices 200 and 300 on the second communication interface.

The second communication unit 220 may communication with the communication device 300 using the second communication interface. The second communication unit 220 may communicate with a second communication unit 320 of the communication device 300 using the second communication interface. The second communication unit 220 may communicate with the second communication unit 320 using the communication linkage information of the communication device 300 on the second communication interface received from the first communication unit 210.

The user interface unit 230 may generate a communication unit active signal according to a control of a user.

The control unit 240 may control the first communication unit 210 and the second communication unit 220. For example, the control unit 240 may activate the first communication unit 210 in response to the communication unit active signal provided from the user interface unit 230.

The control unit 240 may provide the second communication unit 220 with communication linkage information of the communication device 300 on the second communication interface received from the first communication unit 210. Although not shown, the control unit 240 may further comprise a memory for storing communication linkage information received from the first communication unit 210.

The control unit 240 may control the display unit 250 according to a communication state of the first communication unit 210 or the second communication unit 220. For example, the control unit 240 may control the display unit 250 to display a transfer state of communication linkage information of the first communication unit 210. If the first communication unit 210 finishes receiving communication linkage information from the first communication unit 310 using the first communication interface, the control unit 240 may display such a state through the display unit 250. If the second communication unit 220 completes communication linkage with the second communication unit 310 using the second communication interface, the control unit 240 may display such a state through the display unit 250.

The display unit 250 may display a communication state of the first communication unit 210 or the second communication unit 220 according to a control of the control unit 240.

As described above, in comparison with a communication system 10 of FIGS. 1 and 2, the communication system 20 of FIG. 5 may form communication linkage between communication devices 200 and 300 without a control device 100. Thus, it is possible to simplify a communication linkage process between the first and second communication devices 200 and 300. Also, since high-priced equipment (e.g., a computer) for communication linkage between the first and second communication devices 200 and 300 is not needed, a cost may be reduced.

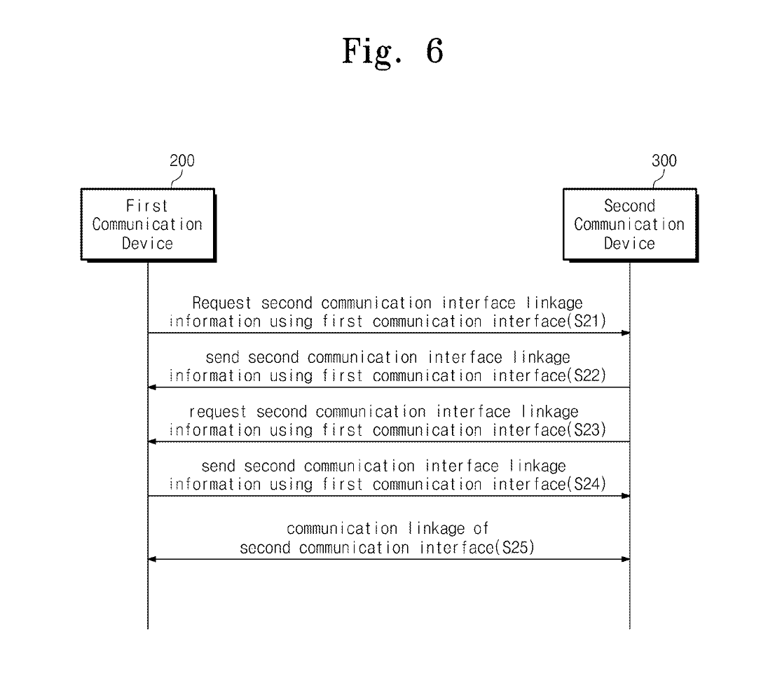

FIG. 6 is a timing diagram for describing operations of communication devices of FIG. 5.

Referring to FIG. 6, a first communication device 200 may request communication linkage information on a second communication interface using a first communication interface at a second communication device 300 (S21).

The second communication device 300 may provide the first communication device 200 with communication linkage information on the second communication interface using the first communication interface (S22).

The second communication device 300 may request communication linkage information on the second communication interface using the first communication interface at the first communication device 200 (S23).

Operations S22 and S23 may be executed simultaneously or sequentially.

The first communication device 200 may provide the second communication device 300 with communication linkage information on the second communication interface using the first communication interface (S24).

The first communication device 200 and the second communication device 300 may complete the communication linkage using the communication linkage information on the second communication interface (S25).

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A control device which controls wireless communication linkage between communication devices, comprising:
a communication unit configured to perform wireless communication with first and second communication devices;
a user interface unit configured to generate a communication unit active signal according to a control of a user; and
a control unit configured to activate the communication unit in response to the communication unit active signal,
wherein the communication unit receives communication linkage information for communication linkage between the first and second communication devices from the first communication device and sends the communication linkage information to the second communication device.

2. The control device of claim 1, wherein the communication unit communicates with the first and second communication devices using a first communication interface and the communication linkage information is communication linkage information for communicating using a second communication interface different from the first communication interface.

3. The control device of claim 2, wherein the first communication interface is an LED, laser or NFC communication interface.

4. The control device of claim 2, wherein the second communication interface is a Zigbee, RFID, Bluetooth, UWB or Wireless LAN communication interface.

5. The control device of claim 2, wherein the communication linkage information comprises channel linkage information which enables the first and second communication device to communicate with each other using the second communication interface.

6. The control device of claim 1, further comprising:
a display unit configured to display a communication state of the communication unit according to a control of the control unit.

7. The control device of claim 1, wherein the user interface unit is formed of a switch, and wherein when the switch is turned on, the user interface unit generates the communication unit active signal.

8. A communication device comprising:
a first communication unit which communicates with an external device through a first communication interface and transmits and receives communication linkage information on a second communication interface different from the first communication interface;
a second communication unit which communicates with the external device through the second communication interface using the communication linkage information received from the first communication unit;
a user interface unit which generates a communication unit active signal according to a control of a user; and
a control unit which activates the first communication unit in response to the communication unit active signal.

9. The communication device of claim 8, further comprising:
a display unit configured to display a communication state of the first or second communication unit according to a control of the control unit.

10. The communication device of claim 8, wherein the communication linkage information comprises channel linkage information which enables the communication device to communicate with the external device using the second communication interface.

11. The communication device of claim 8, wherein the first communication interface is an LED, laser or NFC communication interface and the second communication interface is a Zigbee, RFID, Bluetooth, UWB or Wireless LAN communication interface.
